(19) United States
(12) Patent Application Publication
(10) Pub. No.: US 2004/0164543 A1
(43) Pub. Date: Aug. 26, 2004

(54) Wrap-around lay flat binder

(75) Inventors: Norman C. Yamamoto, Yorba Linda, CA (US); Steve Plorek, Marina del Rey, CA (US)

Correspondence Address: Oppenheimer Wolff & Donnelly, LLP, 840 Newport Center Dr., Ste., 700, Newport Beach, CA, 92660, US

(73) Assignee: Avery Dennison Corporation

(21) Appl. No.: 10/435,101

(22) Filed: May 9, 2003

Related U.S. Application Data
(60) Provisional application No. 60/448,983, filed on Feb. 21, 2003.

(51) Int. Cl. B42D 3/00

(52) U.S. Cl. 281/29

(57) ABSTRACT

Binders disclosed herein include a front cover, a back cover and a spine interconnecting the front cover and the back cover. The spine includes a means for reducing the width of the spine when the front cover is folded back against the back cover.

### CROSS-REFERENCE TO RELATED APPLICATIONS

This application claims the benefit of U.S. Provisional Application No. 60/448,983, filed Feb. 21, 2003, and whose entire contents are hereby incorporated by reference.

### BACKGROUND

Papers and other media have been stored in portfolios, folders, binders, wire-bound notebooks, and the like. Binders, in particular, are a popular choice of storing media due to their ease of use, storage flexibility, and cost effectiveness. Binders are also desirable because papers or other media may be easily inserted and removed from the binders. Furthermore, binders are useful because the stored media may be easily reorganized. While binders are commercially successful and useful, binders may be difficult to use in a confined space. That is, the rigid spine of most prior art binders are typically not designed to have the binder's front cover folded behind the back cover of the binder to provide a substantially flat surface. Additionally, it is difficult to write on the paper contained within prior art binders when the cover is folded back because the writing surface is uneven due to the paper wrapping around the binder and the rings.

### SUMMARY

The exemplary binder embodiments disclosed herein include a collapsible spine that permits the front cover to be wrapped around the back cover to form a substantially flat binder when fully opened. In this fully opened configuration, the binder is space efficient and the substantially flat surfaces of the binder may be utilized as a writing surface. Accordingly, exemplary embodiments of the binder may be used to write in more locations than one would use a typical binder. For example, exemplary binder embodiments may be folded flat and used when writing in one's lap, when writing against one's thigh, or when holding the binder in one arm (like a clip board) to write while standing. The exemplary binder embodiments may be made from a plurality of materials such as, but not limited to, polypropylene, fabric covered chipboards, vinyl covered chipboards, or paper covered chipboard.

According to one exemplary embodiment, the ring binder is composed of a front cover, a back cover and a spine interconnecting the front and back covers. The spine has a width extending from the front cover to the back cover and is associated with a plurality of rings. The binder also includes a means for reducing the width of the spine when the front cover is folded back against the back cover into a fully open, lay-flat configuration. According to one exemplary embodiment, the means for reducing the width of the spine is a longitudinal hinge formed on the spine and a flexible brace positioned on the interior of: the binder.

In another exemplary embodiment, the ring binder is composed of a front cover, a back cover and a spine interconnecting the front and back covers. The binder includes a central longitudinal hinge on the spine and a ring assembly retention device that allow the front cover to be folded back against the back cover to form a fully open, lay-flat configuration. The binder also includes a ring assembly, which is composed of a plurality of mechanically interconnected rings, that is positioned between the spine and the ring assembly retention device.

In yet another exemplary embodiment, the ring binder is composed of a front cover, a back cover and a collapsible spine. These components of the ring binder are formed from a vinyl-covered stiffening board. The collapsible spine includes a first and second spine portion that are coupled together by a central longitudinal hinge. Additionally, a ring assembly is pivotally coupled to the first spine portion. Accordingly, the front cover of the ring binder may be folded against the back cover such that the covers lie substantially flat against one another.

### BRIEF DESCRIPTION OF THE DRAWINGS

FIG. 1 is a perspective view of one exemplary binder embodiment in a closed position;

FIG. 2 is a plan view of the exemplary binder embodiment of FIG. 1 in an open position;

FIG. 3 is a perspective view of the exemplary binder of FIG. 1 in a wrap-around position;

FIG. 4 is a cross-sectional view of FIG. 2 taken alone line 4-4;

FIG. 5 is a side view of FIG. 1;

FIG. 6 is a cross-sectional view of FIG. 3 taken alone line 6-6;

FIG. 7 is a perspective view of another exemplary binder embodiment in a closed position;

FIG. 8 is a plan view of the exemplary binder embodiment of FIG. 7 in an open position;

FIG. 9 is a perspective view of the binder of FIG. 7 in a wrap-around position;

FIG. 10 is a cross-sectional view of FIG. 8 taken alone line 10-10;

FIG. 11 is a side view of FIG. 7;

FIG. 12 is a cross-sectional view of FIG. 9 taken alone line 12-12;

FIG. 13 is a cross-sectional view of FIG. 9 taken alone line 13-13;

FIG. 14 is a perspective view of another exemplary binder embodiment in a closed position;

FIG. 15 is a plan view of the exemplary binder embodiment of FIG. 14 in an open position;

FIG. 16 is a perspective view of another exemplary binder embodiment in a closed position;

FIG. 17 is a plan view of the exemplary binder embodiment of FIG. 16 in an open position;

FIG. 18 is an end view of FIG. 17;

FIG. 19 is an end view of FIG. 16;

FIG. 20 is an end view of the binder in a wrap-around position; and

FIG. 21 is cross-sectional view taken alone line 14-14 of FIG. 16.

### DETAILED DESCRIPTION

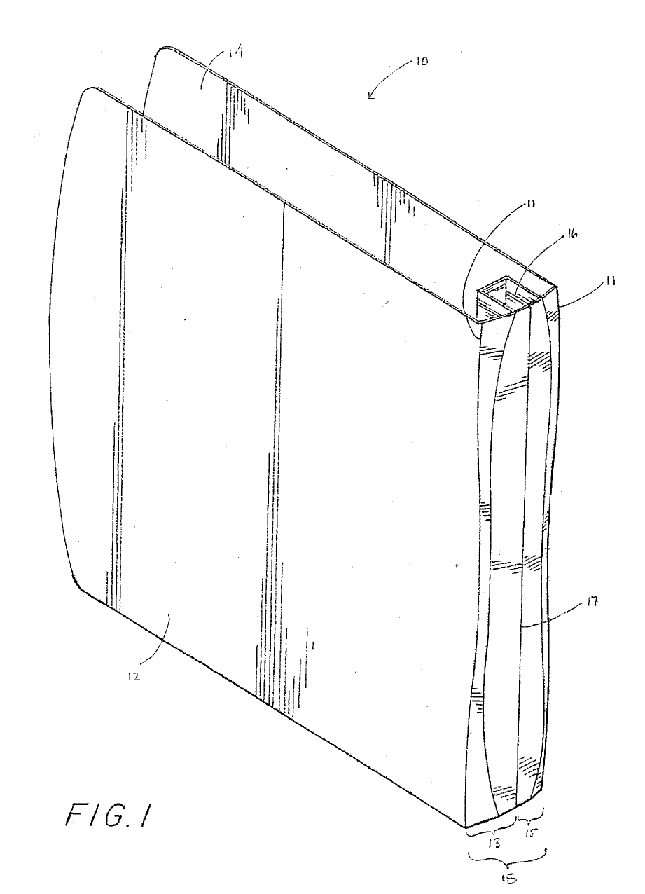

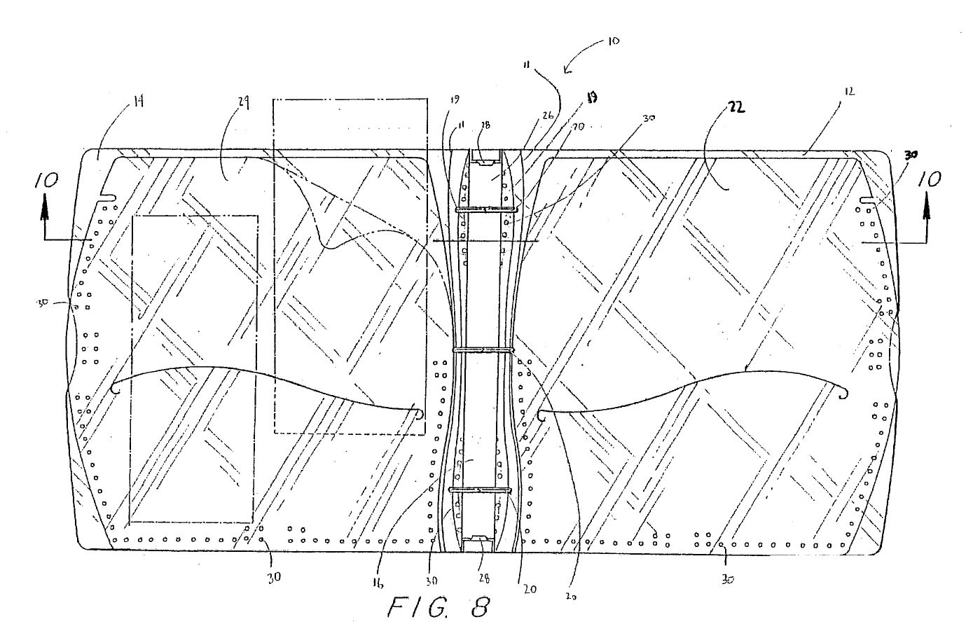

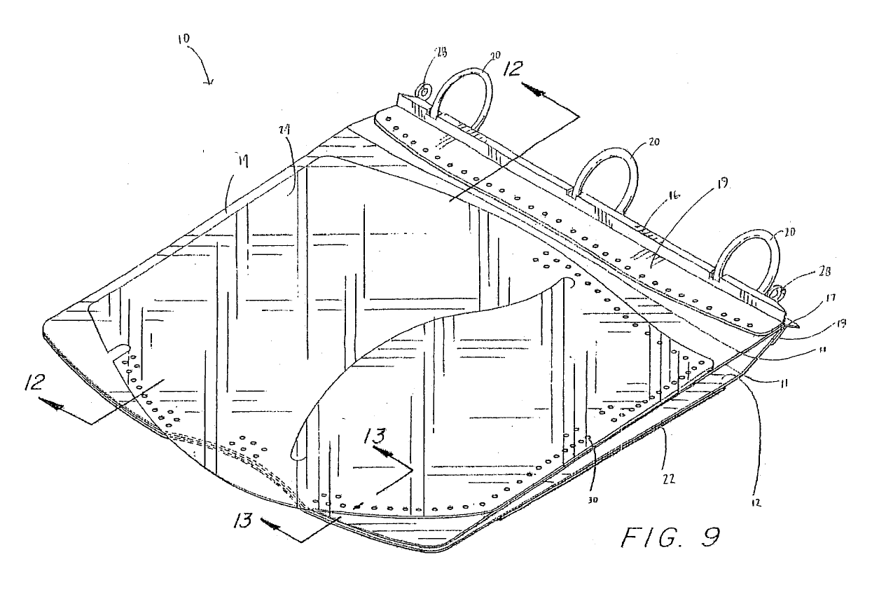

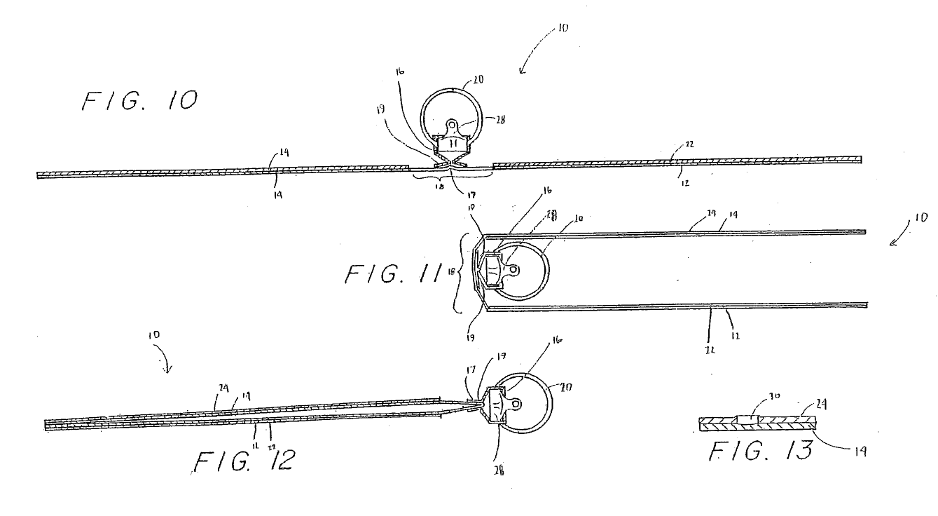

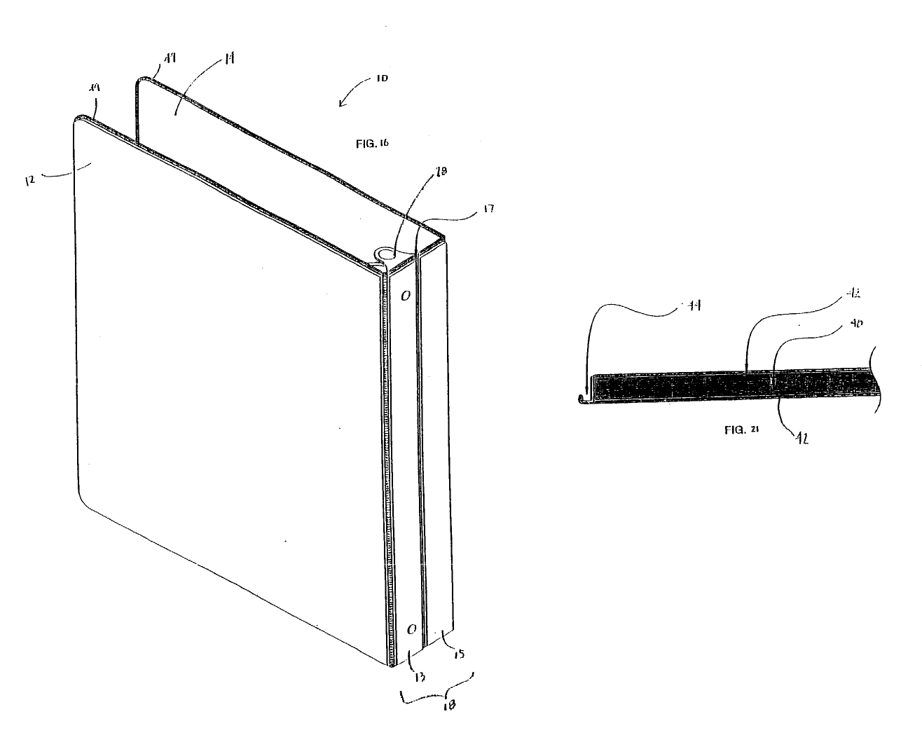

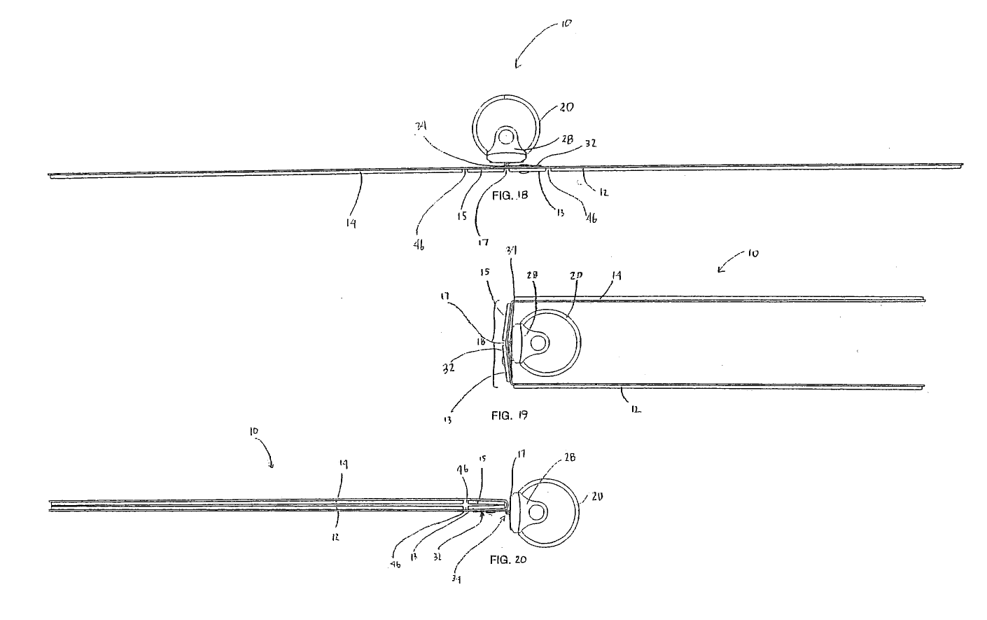

Generally, exemplary embodiments of a binder 10 includes a first cover 12, a second cover 14, a collapsible backbone 18 and a ring assembly 20. As shown in FIGS. 1-21, the ring assembly 20 is composed of 3 rings. However, other exemplary embodiments are contemplated where the ring assembly 20 may be composed of 2 or more rings. Turning to FIG. 1, the first cover 12 and the second cover 14 are coupled to a collapsible backbone 18 by hinges 11. In one exemplary embodiment, the collapsible backbone 18 may be a generally planar member composed of two sections 13, 15 as shown in FIG. 1. The two sections 13, 15 of the collapsible backbone 18 are coupled together by a centered hinge 17. In alternate exemplary embodiments, the collapsible backbone may be composed of two or more sections.

As shown in FIG. 1, the hinges 11 may have a curved shape. The curved shape of the hinges 11 minimizes the collapse of the ring assembly and maintains the rigidity of the collapsible backbone 18 when the binder 10 is in a closed position as shown in FIGS. 1 and 5. More specifically, the curved shape of the hinges 11 imparts stability to the collapsible backbone 18 thereby reducing the amount of flexing (along line 5) that may occur when media is secured within the ring assembly 20. In alternate exemplary embodiments, the hinges 11 may be substantially straight as shown in FIG. 14.

The centered hinge 17, which is positioned between the two sections 13, 15 of the collapsible backbone 18, allows the first cover 12 to be folded over the second cover 14 as shown in FIGS. 3 and 6. That is, the first cover 12 may be folded onto the second cover 14 such that the covers lie substantially flat against one another while maintaining a substantially flat, rigid backbone that allows the contents of the binder to remain in an organized manner.

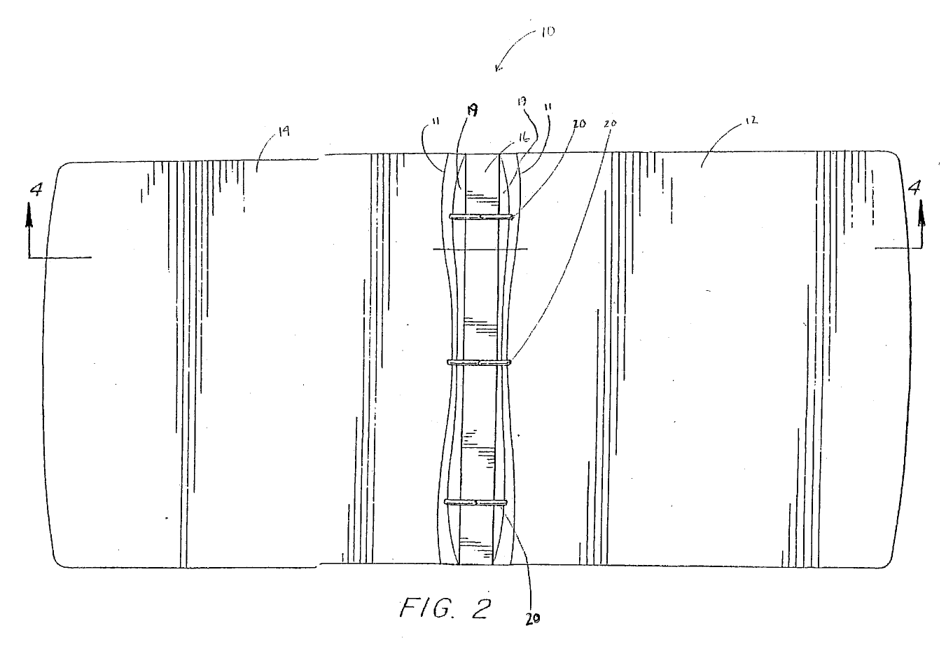

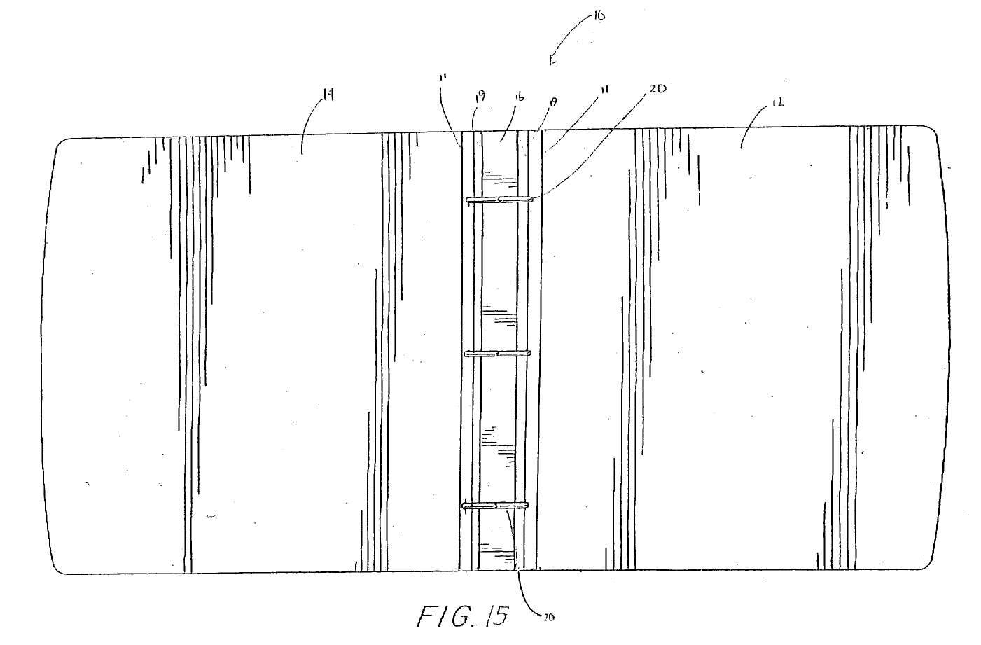

Additionally, as shown in FIG. 1, a ring assembly retention device 16 is flexibly coupled to the collapsible backbone 18. More specifically, a flange 19 provided at the base of the ring assembly retention device 16 to couple the ring assembly retention device to the collapsible backbone as shown in FIGS. 2 and 8. According to one exemplary embodiment, the flanges 19 may have a curved edge as depicted in FIGS. 2 and 8. In another exemplary embodiment, the flanges 19 may have substantially straight edges as shown in FIG. 15. The flanges 19 of the ring assembly retention device are coupled to side walls. The side walls are coupled together by a spine that spans between the side walls.

The ring assembly retention device 16 also includes a plurality of slots 21 that are sized to allow the rings of the ring assembly 20 to protrude through the ring assembly retention device. The ring assembly retention device 16 allows the ring assembly 20 be positioned at the end of the binder when the first cover 12 and the second cover 14 are positioned in a fully opened position as shown in FIGS. 3 and 6.

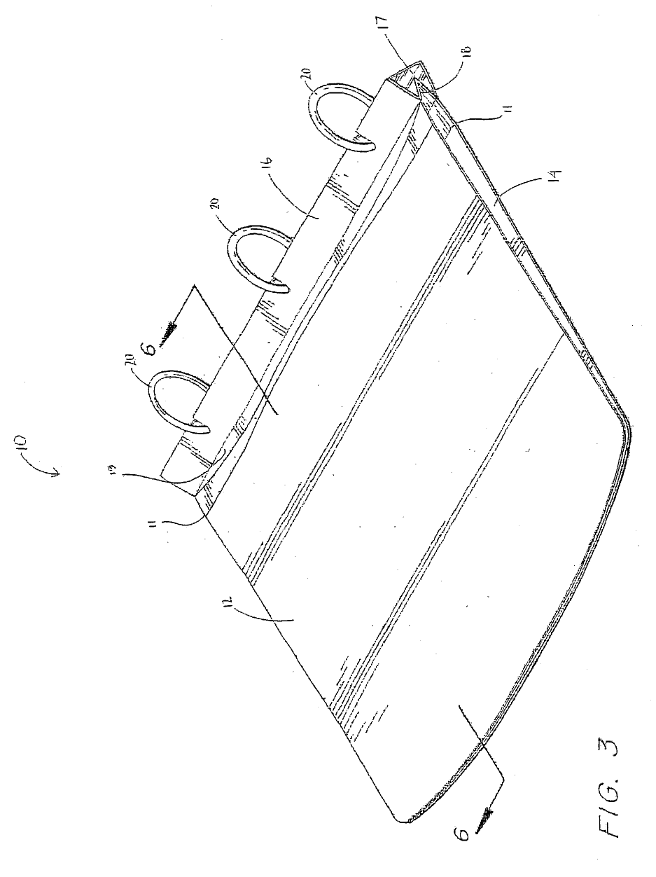

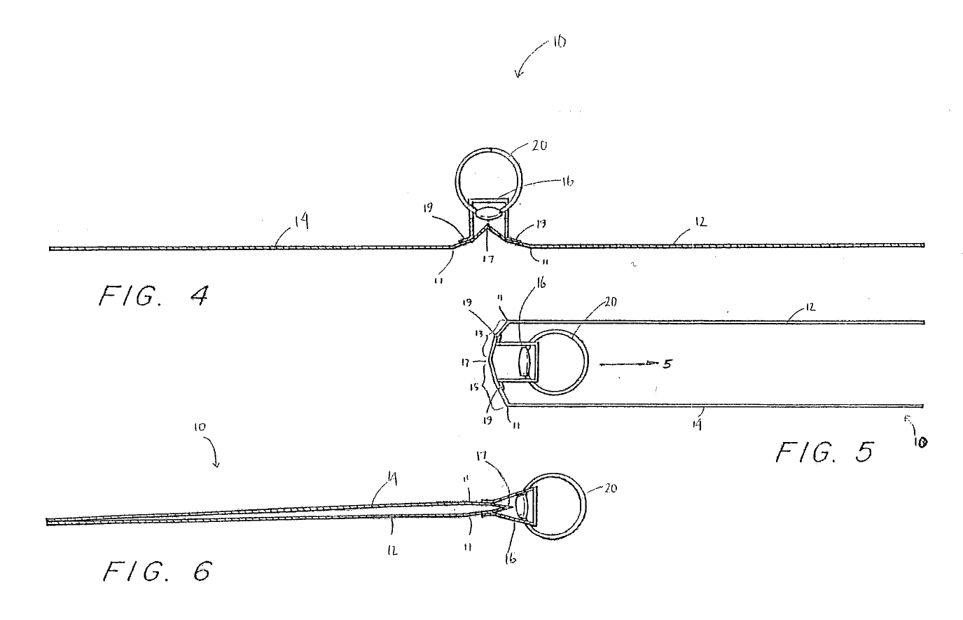

In one exemplary embodiment, the ring assembly retention device 16 is affixed to the inner portion of the collapsible backbone 18 to define a space 27 as shown in FIGS. 1 and 5. A ring assembly 20 is positioned within the space 27 between the ring assembly retention device 16 and collapsible backbone 18 as shown in FIGS. 4-6. The space 27 is sized to allow the ring assembly 20 to be pivotable and movable within the space 27. Accordingly, the ability to move the ring assembly 20 allows for a substantially flat writing surface when the binder 10 is fully opened as shown in FIGS. 3 and 6. Additionally, the ability to move the ring assembly 20 allows more media to be stored on one side of the ring assembly 20.

In another exemplary embodiment, the ring assembly retention device 16 may be sized to substantially fix the ring assembly 20 between the ring assembly retention device 16 and the collapsible backbone 18 as shown in FIGS. 10-12. By fixing the ring assembly 20 substantially adjacent to the surface of the collapsible backbone 18, the ring assembly 20 may include ring boosters 28 to open and close the rings. That is, by providing the ring assembly closer to the surface of the collapsible backbone 18, the leverage required by an individual to open the rings with the ring boosters 28 may be reduced.

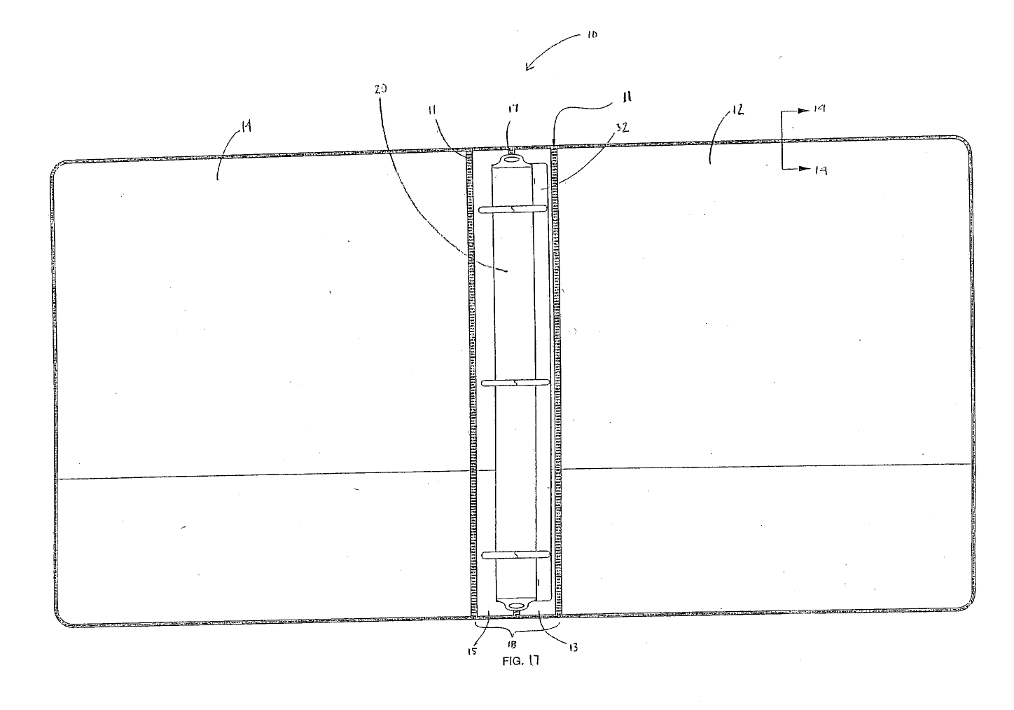

In yet another exemplary embodiment, the ring assembly retention device 16 may be composed of a swing plate 32 that is coupled to both the collapsible backbone 18 and the ring assembly 20 as shown in FIGS. 18-20. The swing plate 32 also includes a hinge 34 that allows the ring assembly 20 to be pivoted. As shown in FIGS. 1-20, the hinge 34 is positioned over the central hinge 17 of the collapsible backbone 18. Accordingly, the ability to move the ring assembly 20 allows for a substantially flat writing surface and allows the ring assembly to hold a larger amounts of media within the ring assembly 20. Additionally, the ring assembly coupled to the swing plate would allow any binder, which uses a standard loose-leaf style ring assembly, be capable of folding back on itself to make the surface more writable.

According to the exemplary embodiment depicted in FIGS. 1-16, the first cover 12, the second cover 14 and the collapsible backbone 18 may be made of plastic material such as, but not limited to, polypropylene. In an alternate exemplary embodiment, it is also contemplated that these components may be made of other rigid plastic materials. In exemplary embodiment depicted in FIGS. 16-21, the first cover 12, the second cover 14 and the collapsible backbone 18 are made of cardboard chipboard enveloped by vinyl sheeting as shown in FIG. 21. In other exemplary embodiments, the binder may be made from materials such as, but not limited to, fabric covered chipboards, polypropylene covered chipboards, or paper covered chipboards.

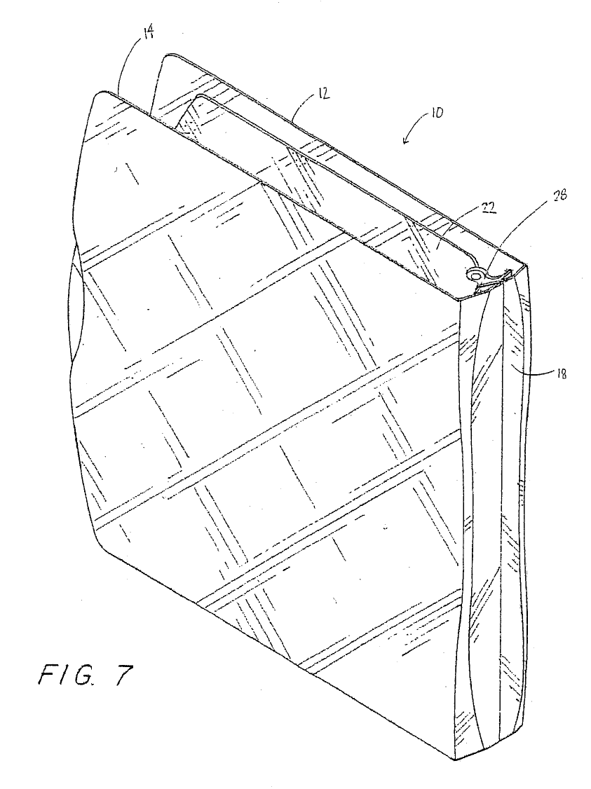

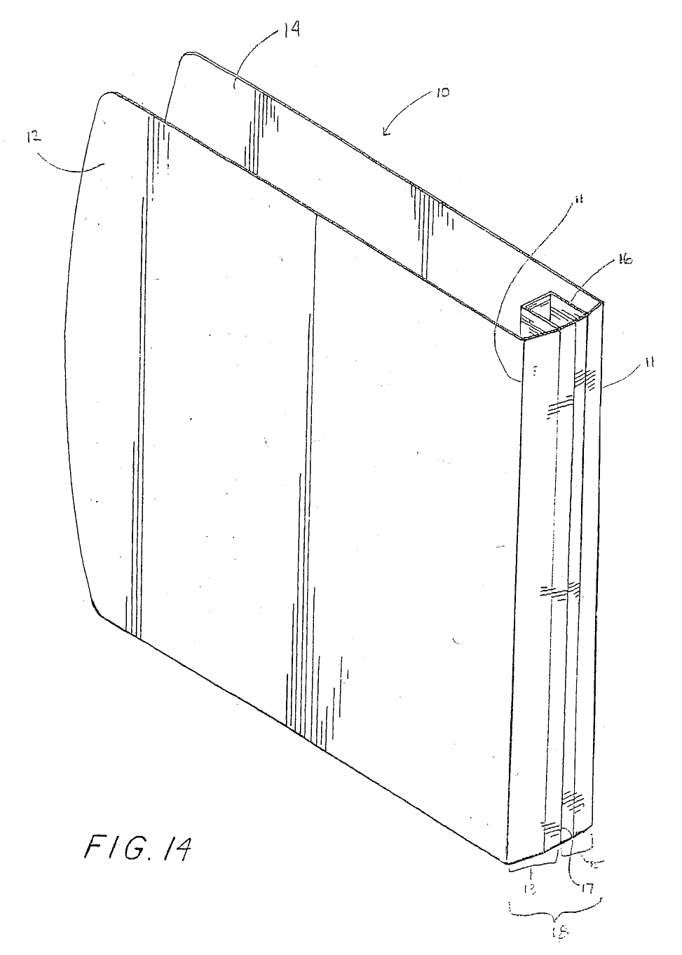

FIG. 8 illustrates another exemplary binder embodiment wherein the first cover 12 and the second cover 14 also include panels 22, 24 that may be affixed to the inner surfaces of the first and second covers. As shown in FIGS. 8 and 13, the panels may be affixed to the covers by rivet-shaped heat seals 30. The heat seals 30 are positioned around the periphery of the panels so as to allow the storage of papers or other media in the space between the panels 22, 24 and the covers 12, 14. As shown in FIGS. 7-12, the binder includes the ring assembly retention device 16 that keeps the ring assembly 20 relatively close to the surface of the collapsible backbone 18.

FIGS. 16-21 illustrates yet another exemplary binder embodiment wherein the walls of the binder are composed of a vinyl-cardboard-vinyl sandwich. That is, a cardboard base 40 or other paper-based material is enveloped by a vinyl sheeting 42 as shown in FIG. 21. The vinyl sheeting 42 is then heat sealed along the seams 44 to envelope the cardboard base 40. The hinges 46 between the covers and the collapsible backbone are spaces where there is no cardboard base and the vinyl sheeting 42 is heat sealed together. This exemplary binder embodiment may utilize a standard ring assembly that is coupled to the collapsible backbone by a swing arm 34.

Additional objects and advantages of the exemplary binder embodiments will become readily apparent to those skilled in the art. The exemplary embodiments are shown and described, simply by way of illustration of the best mode contemplated of carrying out these exemplary embodiments. It is also contemplated that the exemplary embodiments are capable of modification in various respects, all without departing from the scope and spirit of the disclosed exemplary embodiments described herein. Accordingly, the drawings and description are illustrative and not intended to be a limitation thereof.

What is claimed is:

1. A ring binder comprising:
a front cover;
a back cover;
a spine interconnecting said front cover and said back cover, said spine having a width extending from said front cover to said back cover;
a plurality of rings associated with said spine; and
means for reducing said width of said spine when said front cover is folded back against said back cover into a fully open, lay-flat configuration.

2. A ring binder as defined in claim 1, wherein said binder further comprises a trigger for opening said rings.

3. A ring binder as defined in claim 1, wherein said means for reducing said width of said spine comprises:
a longitudinal hinge formed on said spine;
and a flexible brace on the interior of said binder.

4. A ring binder as defined in claim 3, wherein said brace has a foot, a first side portion, a brace spine, a second side portion, and a second foot, said first and second feet being attached to said binder spine, said brace providing openings for respective rings, wherein said binder spine folds at said longitudinal hinge into a space defined by said first brace side portion, said brace spine, and said second brace side portion.

5. A ring binder as defined in claim 4, wherein said feet are flexibly hinged to said first and second side portions, respectively.

6. A ring binder as defined in claim 5, wherein said feet attached to said spine immediately adjacent to said longitudinal hinge, on either side of said hinge, respectively.

7. A ring binder as defined in claim 3, wherein said brace further comprises a third side portion intermediate said foot and said first side portion, and a fourth side portion intermediate said second foot and said second side portion, said third and fourth side portions extending diagonally toward one another from the first and second side portions, respectively, to an area proximate to said longitudinal hinge, said feet being flexibly hinged to said third and fourth side portions, respectively, said feet being attached to said spine adjacent to said longitudinal hinge, on opposite sides of said hinge, respectively.

8. A ring binder as defined in claim 3, wherein said flexible brace extends the entire longitudinal dimension of said spine.

9. A ring binder as defined in claim 3, wherein said flexible brace extends less than the entire longitudinal dimension of said spine.

10. A ring binder as defined in claim 1, wherein said binder is formed of polypropylene.

11. A ring binder as defined in claim 1, wherein said binder is a vinyl binder comprising vinyl-covered stiffening board, said binder having a front cover, a first spine portion, a second spine portion, and a back cover, said front cover, said first spine portion, said second spine portion, and said back cover being separated from each other by a respective longitudinal hinge.

12. A ring binder as defined in claim 11, wherein said binder further comprises a ring assembly comprising a plurality of mechanically interconnected rings, said ring assembly being attached to one of said first spine portion and said second spine portion, but not the other, thereby permitting said binder to open into a fully-open, substantially lay-flat configuration.

13. A ring binder as defined in claim 4, wherein said first foot and said second foot have at least one curved edge.

14. A ring binder comprising:
a front cover;
a back cover;
a spine interconnecting the front cover and the back cover, the spine having a central longitudinal hinge;
a ring assembly retention device coupled to the spine; and
a ring assembly positioned between the spine and the ring assembly retention device.

15. A ring binder as defined in claim 14, wherein the front cover and the back cover are coupled to the spine by straight hinges.

16. A ring binder as defined in claim 14, wherein the front cover and the back cover are coupled to the spine by curvilinear hinges.

17. A ring binder as defined in claim 16, wherein the ring assembly retention device comprises a base flange coupled to a first side portion; the first side portion coupled to brace spine; a brace spine coupled to a second side portion; a second side portion coupled to a second base flange.

18. A ring binder as defined in claim 16, wherein the base flange and the second base flange have at least one curvilinear edge.

19. A ring binder as defined in claim 16, wherein the base flange and the second base flange have straight edges.

20. A ring binder as defined in claim 14, wherein the ring binder is formed of polypropylene.

21. A ring binder comprising:
a front cover hingedly coupled to a collapsible spine;
a back cover hingedly coupled to the collapsible spine; and
the collapsible spine comprising a first spine portion interconnected to a second spine portion by a central longitudinal hinge, and a ring assembly pivotally coupled to the first spine portion, wherein the ring assembly comprises a plurality of mechanically interconnected rings.

22. A ring binder as defined in claim 21, wherein the ring assembly is coupled to the first spine portion by a swing arm, wherein the swing arm comprises a first plate, a second plate, and a hinge coupling the first plate to the second plate, and wherein the hinge of the swing arm is positioned over the central longitudinal hinge.
